(19) United States
(12) Patent Application Publication
(10) Pub. No.: US 2011/0174341 A1
(43) Pub. Date: Jul. 21, 2011

(54) CONNECTABLE DOSING DEVICE

(76) Inventors: Arnd Kessler, Monheim am Rhein (DE); Salvatore Fileccia, Oberhausen (DE); Dieter Eichholz, Iserlohn (DE); Gerold Jans, Waldburg (DE)

(21) Appl. No.: 12/986,322

(22) Filed: Jan. 7, 2011

Related U.S. Application Data
(63) Continuation of application No. PCT/EP2009/058959, filed on Jul. 14, 2009.

(30) Foreign Application Priority Data
Jul. 15, 2008 (DE) 10 2008 033 108.2

(51) Int. Cl. B08B 3/00

(52) U.S. Cl. 134/93

(57) ABSTRACT

A dosing system, in particular for positioning on or within a dishwasher, comprising at least one cartridge for free-flowing washing or cleaning agents with a number of chambers for physically separate housing of different preparations of a washing or cleaning agent and a dosing device which may be connected to the cartridge, comprising at least one power source, a controller, a sensor unit, at least one actuator, connected to the power source and the controller such that a control signal from the controller brings about a movement of the actuator, a sealing element, coupled to the actuator such that a movement of the actuator puts the sealing element in a sealing or an open position, at least one dosing chamber, in communication with at least one of the cartridge chambers when the cartridge and dosing device are assembled, wherein the dosing chamber has an inlet for the inflow of washing or cleaning agent from a cartridge chamber and an outlet for the outflow of washing or cleaning agent from the dosing chamber into the surroundings, wherein at least the outlet of the dosing chamber may be sealed or opened by the sealing element, wherein the dosing device has a least one first interface which interacts with a corresponding interface on a water-using device such as in particular a domestic water-using device, preferably a dishwasher or washing machine such that a transmission of signals and/or electric power from the water-using device to the dosing device is possible.

### CROSS REFERENCE TO RELATED APPLICATIONS

This application is a continuation of PCT/EP2009/058959, filed on Jul. 14, 2009, which claims priority under 35 U.S.C. §119 to DE 10 2008 033 108.2 filed on Jul. 15, 2008.

### BACKGROUND OF THE INVENTION

1. Field of the Invention

The invention relates to a dispensing system, couplable to a water-conveying device, for releasing a plurality of preparations for use in water-conveying devices, in particular water-conveying domestic appliances, for example dishwashing machines, washing machines, laundry dryers, or automatic surface cleaning systems.

2. Description of the Prior Art

Automatic dishwashing agents are available to consumers in numerous presentations. In addition to traditional liquid manual dishwashing agents, automatic dishwashing agents have in particular become increasingly significant as domestic dishwashing machines have become more common. These automatic dishwashing agents are typically offered for sale to the consumer in solid form, for example as a powder or as tablets, but increasingly also in liquid form. For some considerable time, attention has focused on convenient dispensing of washing and cleaning agents and on simplifying the operations required to carry out a washing or cleaning method.

Furthermore, one of the main objectives of manufacturers of automatic cleaning agents is to improve the cleaning performance of these agents, increasing attention having been paid in recent times to cleaning performance in low temperature cleaning cycles or in cleaning cycles with reduced water consumption. To this end, new ingredients, for example more highly active surfactants, polymers, enzymes or bleaching agents have been added to the cleaning agents. However, since new ingredients are only available to a limited extent and the quantity of the ingredients used per cleaning cycle cannot be increased at will for environmental and economic reasons, there are natural limits to this approach to solving the problem.

In this connection, devices for multiple dispensing of washing and cleaning agents have recently come to the attention of product developers. In terms of these devices, a distinction may be drawn between dispensing chambers integrated into the dishwashing machine or washing machine, on the one hand, and separate devices independent of the dishwashing machine or washing machine, on the other hand. These devices, which contain a multiple of the quantity of cleaning agent required to carry out a cleaning method, automatically or semi-automatically dispense washing or cleaning agent portions into the interior of the cleaning machine over the course of a plurality of successive cleaning processes. For the consumer, manual dispensing for each cleaning or washing cycle is no longer necessary. Examples of such devices are described in European patent application EP 1 759 624 A2 (Reckitt Benckiser) or in German patent application DE 53 5005 062 479 A1 (BSH Bosch and Siemens Hausgeräte GmbH).

Autonomous dispensing systems for dishwashing machines that comprise a mechanical energy reservoir, which are embodied e.g. by a combination of bimetals, shape memory alloys, and/or springs, or electrical energy reservoirs in the form of batteries or rechargeable batteries, are known in the existing art.

Although an electrical energy source is preferable for an autonomous dispensing system, in particular because of the use of electrical control systems and the accurate and simple control system for the dispensing system associated therewith, such dispensing system nevertheless have the disadvantage of possessing only a limited service life because of the capacity of their battery or rechargeable battery.

### BRIEF SUMMARY OF THE INVENTION

The object of the invention is therefore to make available an autonomous dispensing system, having an electrical energy source, that has a long service life.

A substantial advantage is that the dispensing system allows an extended service life, which for example is not limited by the capacity of a battery, to be achieved for the dispensing system. It is moreover possible to embody the dispensing system as both an autonomous and a device-integrated dispensing solution.

The dispensing system according to the invention consists of the basic components of a cartridge filled with preparation and a dispenser couplable with the cartridge, which is in turn formed of further assemblies, such as for example component carrier, actuator, closing element, sensor, energy source and/or control unit.

It is preferred for the dispensing system according to the invention to be mobile. For the purposes of the present application, mobile means that the dispensing system is not nondetachably connected to a water-conveying device, such as for example a dishwashing machine, washing machine, washer/dryer or the like, but may instead be removed for example from a dishwashing machine by the user or be positioned in a dishwashing machine, i.e. may be handled separately.

According to an alternative development of the invention, it is also conceivable for the dispenser to be connected nondetachably for the user to a water-conveying device such as for example a dishwashing machine, washing machine, washer/dryer or the like and for only the cartridge to be mobile.

In order to ensure operation at elevated temperatures, as may for example occur in individual washing cycles of a dishwashing machine, the dispensing system may be formed from materials which are dimensionally stable up to a temperature of 120° C.

Since, depending on the intended purpose, the preparations to be dispensed may have a pH value of between 2 and 12, any components of the dispensing system which come into contact with the preparations should exhibit appropriate acid and/or alkali resistance. In addition, suitable material selection should ensure that these components are as far as possible chemically inert, for example in relation to nonionic surfactants, enzymes and/or scents.

### BRIEF DESCRIPTION OF THE DRAWINGS

FIG. 1 Autonomous dispenser with two-chamber cartridge in the separated and assembled states

FIG. 2 Autonomous dispenser with two-chamber cartridge arranged in a drawer of a dishwashing machine

FIG. 3 Two-chamber cartridge in the separated and assembled state, for an autonomous dispenser integratable into the machine

FIG. 4 Two-chamber cartridge in the assembled state, for an autonomous dispenser integrated into the machine

FIG. 5 Combi dispenser with transmit and receive unit

FIG. 6 Combi dispenser with transmit and receive unit with open dispensing chamber lid

FIG. 7 Combi dispenser with receptacle for external dispenser

FIG. 8 Dispenser and transmitter arranged in domestic appliance

FIG. 9 Dispenser and transmitter arranged in domestic appliance, with domestic appliance loaded

FIG. 10 Dispenser and transmitter emitting two signal types arranged in domestic appliance

FIG. 11 Dispenser with transmitter emitting two signal types and receiver in domestic appliance

FIG. 12 Dispenser with optical transmitter, couplable cartridge and transmitters and/or receivers on domestic appliance

FIG. 13 Dispensing apparatus in the plate receptacle of a crockery drawer

FIG. 14 Dispenser and cartridge in exploded view

FIG. 15 Component carrier in front view

### DETAILED DESCRIPTION OF THE INVENTION

FIG. 1 shows an autonomous dispenser 2 with a two-chamber cartridge 1 in the separated and assembled states.

The dispenser 2 comprises two dispensing chamber inlets 21a, 21b for repeatedly detachable accommodation of the corresponding outlet orifices 5a, 5b of the chambers 3a, 3b of the cartridge 1. Indicator and operating elements 37, which indicate the operating state of the dispenser 2 or have an effect thereon, are located on the front.

The dispensing chamber inlets 21a, 21b additionally comprise means which, when the cartridge 1 is placed on the dispenser 2, bring about opening of the outlet orifices 5a, 5b of the chambers 3a, 3b, such that when dispenser 2 and cartridge 1 are in the coupled state, the interior of the chambers 3a, 3b is connected in communicating manner to the dispensing chamber inlets 21a, 21b.

The cartridge 1 may consist of one or more chambers 3a, 3b. The cartridge 1 may be of single-part construction comprising a plurality of chambers 3a, 3b or be of multi-part construction, wherein the individual chambers 3a, 3b are then assembled to form a cartridge 1, in particular by bonded, interlocking or frictional connection methods.

In particular, fixing may be effected by one or more of the connection types from the group of snap-in connections, press connections, melt connections, adhesive connections, welded connections, brazed connections, screw connections, keyed connections, clamped connections or rebound connections In particular, fixing may also be provided by a heat-shrinkable sleeve, which is drawn in the heated state over at least portions of the cartridge and firmly envelops the cartridge in the cooled state.

The bottom of the cartridge 1 may be inclined in the manner of a funnel towards the release orifice 5a, 5b in order to provide the cartridge 1 with advantageous residual emptying characteristics. Moreover, the internal wall of the cartridge 1 may be constructed by suitable material selection and/or surface finish such that the product adheres only slightly to the internal wall of the cartridge. The residual emptying characteristics of the cartridge 1 may also be further optimized by this measure.

The chambers 3a, 3b of a cartridge 1 may be of identical or different capacities. In a configuration with two chambers 3a, 3b, the ratio of the chamber volumes is preferably 5:1; in a configuration with three chambers preferably 4:1:1, these configurations in particular being suitable for use in dishwashing machines.

One possible connection method may also consist in plugging the chambers 3a, 3b into one of the corresponding dispensing chamber inlets 21a, 21b of the dispenser 2 and thereby fixing them relative to one another.

The connection between the chambers 3a, 3b may in particular be detachable, so as to allow separate replacement of chambers.

The chambers 3a, 3b each contain a preparation 40a, 40b. The preparation 40a, 40b may be of the same or different composition.

Advantageously, the chambers 3a, 3b are made of a transparent material, such that the filling level of the preparations 40a, 40b is visible to the user from outside. It may however also be advantageous to make at least one of the chambers from an opaque material, in particular when the preparation located in this chamber contains light-sensitive ingredients.

The outlet orifices 5a, 5b are designed such that they form an interlocking and/or frictional, in particular liquid-tight, connection with the corresponding dispensing chamber inlets 21a, 21b.

It is particularly advantageous for each of the outlet orifices 5a, 5b to be configured such that it fits onto only one of the dispensing chamber inlets 21a, 21b, so preventing a chamber from being inadvertently plugged onto an incorrect dispensing chamber inlet. This may be achieved for example by outlet orifices 5a, 5b and/or dispensing chamber inlets 21a, 21b which differ in size or basic shape.

The cartridge conventionally has a capacity of <5000 ml, in particular <1000 ml, preferably <500 ml, particularly preferably <250 ml, very particularly preferably <50 ml.

In the assembled state, the dispensing unit 2 and the cartridge 1 may be adapted in particular to the geometries of the devices on or in which they are used, so as to ensure the smallest possible loss in useful volume. To use the dispensing unit 2 and the cartridge 1 in dishwashing machines it is particularly advantageous to shape the dispensing unit 2 and the cartridge 1 in imitation of dishes to be cleaned in dishwashing machines. The dispensing unit 2 and the cartridge 1 may, for example, be plate-shaped, approximately assuming the dimensions of a plate. In this way, the dispensing unit may be positioned in space-saving manner in the lower basket.

The outlet orifices 5a, 5b of the cartridge 1 are preferably arranged in a line or row, so making a slender, plate-shaped configuration of the dispenser possible.

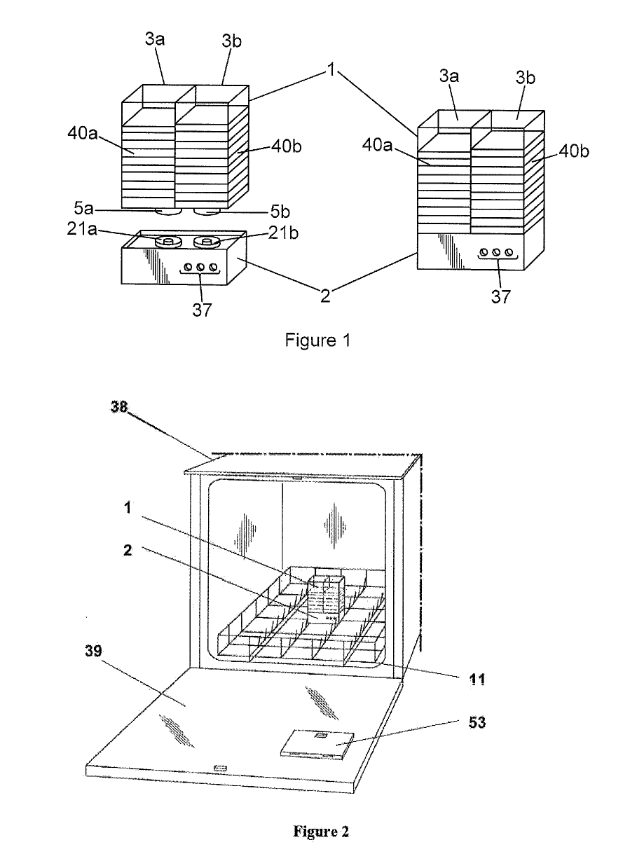

FIG. 2 shows an autonomous dispenser with a two-chamber cartridge 1 in the crockery drawer 11 when the door 39 of a dishwashing machine 38 is open. It will be noted that the dispenser 2 may be positioned together with the cartridge 1 in principle at any desired point within the crockery drawer 11, wherein it is advantageous for a plate- or cup-shaped dispensing system 1, 2 to be provided in a corresponding plate or cup receptacle in the crockery drawer 11. In the dishwashing machine door 39 there is located a dispensing chamber 53, into which a dishwashing machine cleaning preparation may be introduced, for example in the form of a tablet. If the dispensing system 1, 2 is in the operational state inside the dishwasher 38, the addition of cleaning preparation for each washing cycle via the dispensing chamber 53 is not necessary, since cleaning agent release is provided for a plurality of washing cycles via the dispensing system 1, 2, this being explained below in greater detail. An advantage of this embodiment of the invention is that, when the autonomous dispensing system 1, 2 is arranged in the lower crockery drawer 11, preparations 40a, 40b are released from the cartridge 1 directly via the outlet orifices arranged on the dispenser into the washing liquor, such that quick dissolution and uniform distribution of the washing preparations in the washing program is ensured.

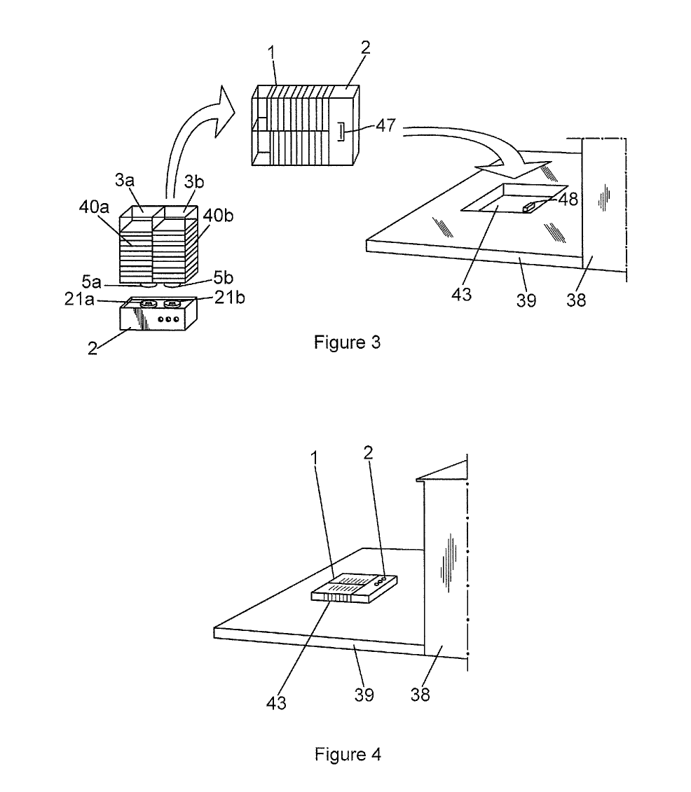

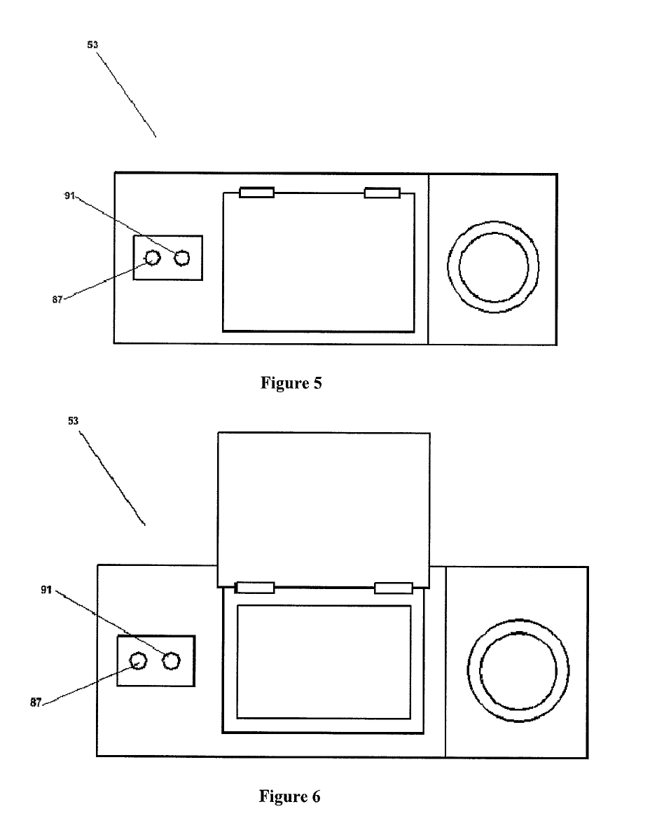

A further development of the invention is shown in FIG. 3 and FIG. 4. The dispenser 2 may here be coupled to the cartridge 1, this being indicated accordingly in the drawing by the first, left-hand arrow. Then, cartridge 1 and dispenser 2 are coupled as an assembly via the interface 47, 48 to the dishwasher, as shown by the right-hand arrow. The dispenser 2 comprises an interface 47, via which data and/or energy are transmitted to and/or from the dispenser 2. In the door 39 of the dishwasher 38 a recess 43 is provided for accommodating the dispenser 2. In the recess 43 a second interface 48 is provided, which transmits data and/or energy to and/or from the dispenser 2.

Preferably, data and/or energy are exchanged wirelessly between the first interface 47 on the dispenser 2 and the second interface 48 on the dishwasher 38. It is particularly preferable for energy to be transmitted from the interface 48 of the dishwasher 38 wirelessly via the interface 47 to the dispenser 2. This may, for example, proceed inductively and/or capacitively.

It is furthermore advantageous for the interface for data transmission also to be of wireless configuration. This may be achieved using the methods known in the prior art for wireless data transmission, such as for example by means of radio transmission or IR transmission. It is particularly preferable for data and signal transmission to take place wirelessly by means of optical transmission technologies using the visible range.

Alternatively, the interfaces 47, 48 may also take the form of integral plug-in connections. Advantageously, the plug-in connections are configured in such a way that they are protected from the ingress of water or moisture.

FIG. 4 shows the dispensing system 1, 2 coupled to the dishwashing machine 38 in the recess 43 in the dishwashing machine door 39.

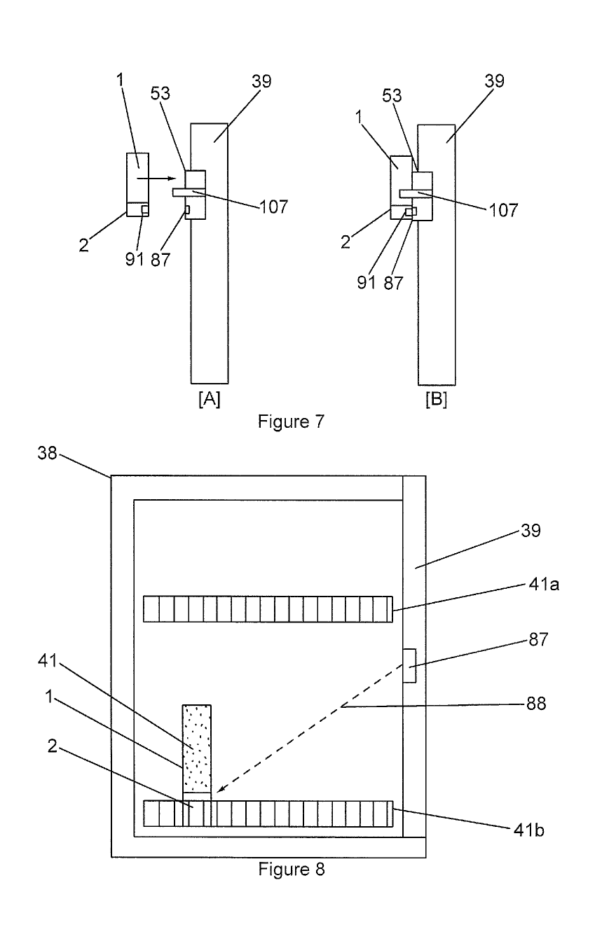

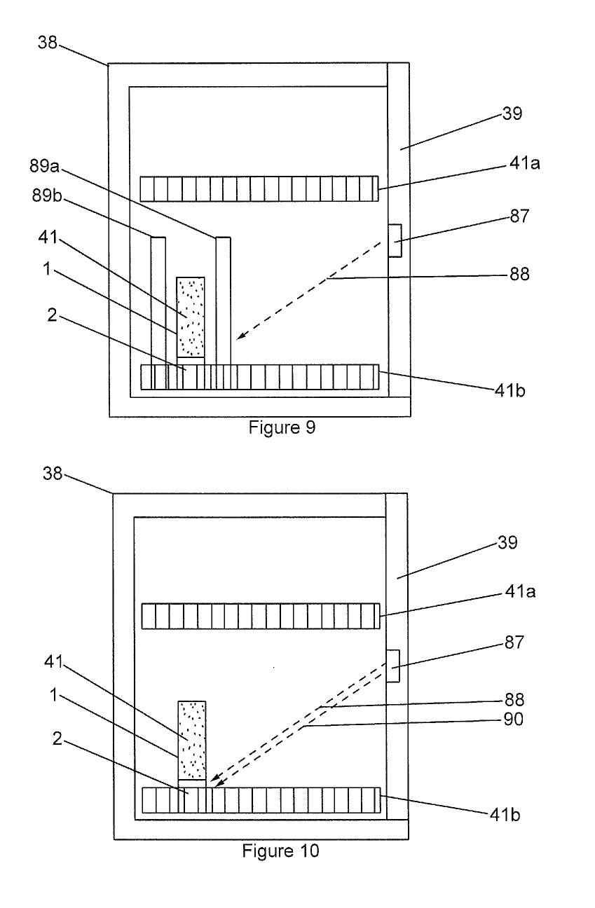

FIG. 5 shows a dispensing chamber 53 into which a transmit unit 87 and a receive unit 91 have been integrated. Such a dispensing chamber 53 is also known as a combi dispenser. The dispensing chamber 53 comprises a receptacle, closable by a coupled-on closing lid, for a dishwashing agent. FIG. 6 shows the closing lid in its open position. In addition, the dispensing chamber 53 may also comprise a receptacle for a rinse aid, which is indicated by the circular closure to the right of the closing lid in FIGS. 5 and 6.

The transmit unit 87 comprises a luminous means, which is arranged in the transmit unit 87 in such a way that the luminous means radiates into the interior of the dishwashing machine. The luminous means may in particular be an LED or a laser diode. The LED is arranged such that it projects out of the plane of the transmit unit 87, such that the LED produces the largest possible angle of radiation.

The transmit unit 87 may be configured in such a way that the LED is provided both for emitting signals inside the dishwasher 38, in particular when the dishwashing machine door 39 is closed, and for optical display of an operating state, for example the filling level of the salt or rinse aid storage container of a dishwashing machine, in particular when the dishwashing machine door 39 is open.

The receive unit 91 preferably consists of a photodiode, which is suitable for detecting light signals from the interior of the dishwashing machine. Like the transmit unit 87, the photodiode of the receive unit 91 may also project out of the plane of the receive unit in order as far as possible to optimize irradiation characteristics onto the photodiode.

It is also possible for the dispensing chamber 53 to comprise a receptacle 107, by means of which a mobile dispensing system consisting of dispenser 2 and cartridge 1 may be coupled detachably or fixedly with the dispensing chamber 53. This is shown schematically in FIG. 7.

In this variant embodiment, the dispensing chamber 53 is integrated fixedly into a dishwashing machine door 39. The dispenser 2 comprises a receive unit 91, which is suitable for receiving signals from the transmit unit 87 of the dispensing chamber 53. As is clear from FIG. 7 (B), when dispensing system and dispensing chamber 53 are in the coupled state, the receive unit 91 on the dispenser and the transmit unit 87 on the dispensing chamber lie directly opposite one another, so achieving the smallest possible distance between transmit unit 87 and receive unit 91.

The receptacle 107 may form for example an interlocking and/or frictional detachable or fixed connection, for example a snap-fit/latching connection, with the dispensing system.

How the transmit unit 87 interacts with a dispenser 2 arranged inside a dishwashing machine 38, in particular in a crockery drawer, is explained below with reference to FIGS. 8 to 12.

FIG. 8 will be examined first of all. A dishwashing machine 38 is shown in a schematic cross-sectional view. Inside the dishwashing machine 38, arranged one above the other, are two crockery drawers 41a, 41b for accommodating items to be washed such as for example plates, cups etc. The dishwashing machine 38 has a swivelable door 39, which is shown closed in FIG. 8. Integrated into the dishwashing machine door 39 is a transmit unit 87, which is coupled to the controller of the dishwashing machine 38. Preferably, the transmit unit 87 is integrated into a combi dispenser 53 according to FIGS. 5-6.

The transmit unit 87 comprises an LED, which emits an optical signal 88, which bears control information, into the interior of the dishwashing machine 38. This signal and the direction thereof are indicated by the arrow in FIG. 8. The broken line of the arrow indicates that the optical signals 88 emitted by the transmit unit 87 are photoflashes or light pulses.

The dispenser 2 with a cartridge 1 is positioned in the lower crockery drawer 41b. It goes without saying that it is possible to arrange the dispenser 2 with the cartridge 1 at any desired, suitable location in the lower or upper crockery drawer 41, wherein plate receptacles provided in or on the crockery drawer 41 are preferable for arrangement of the dispenser 2.

The dispenser 2 has a receive unit 91, which is not shown in FIG. 8. The optical signals 88 emitted by the transmit unit 87 are received by the receive unit 91 of the dispenser 2 and evaluated or converted by the control unit of the dispenser 2.

At the start in particular of a washing program, an optical signal 88 may be emitted by the transmit unit 87, which signal, after reception by the dispenser 2, has the effect that control of the dispenser 2, in particular control of dispensing times and quantities, is transferred to the controller of the dishwashing machine 38. This is particularly advantageous when the controller of the dispenser 2 has its own dispensing programs for operation autonomously of the dishwashing machine 38, but these programs are not to be executed upon detection of a corresponding signal 88 from a transmit unit 87 which is present.

FIG. 9 shows a situation in which the dispenser 2 cannot receive any signals from the transmit unit 87, since for example the dispenser 2 in the crockery drawer 41b is surrounded by items to be washed (objects) 89a, 89b in such a way as to prevent reception of signals 88 from and to the transmit unit 87. This may also be the case for example if items to be washed fall over during the course of a dishwashing program.

In this case where the signals 88 are not received at the dispenser 2 or are interrupted, a dispensing program from the control unit of the dispenser 2 is activated, such that the dispenser 2 dispenses at least one preparation 40 during a washing program autonomously of the controller of the dishwashing machine 38. This prevents a situation in which signal interruption results in no preparation 40 being released into the interior of a dishwashing machine 38 during a washing program, resulting in poor cleaning performance. This applies to situations both at the start of a washing program and during a washing program.

To identify signal interruption between the dispenser 2 and the transmit unit 87, an additional monitoring signal 90 may be provided, which is emitted at predefined, fixed time intervals by the transmit unit 87, while the control signal 88 is emitted at fixed time intervals or merely on direct transmission of a control signal. This is outlined by way of example in FIG. 10. Since the transmit unit 87 is conventionally operated via the mains connection of the dishwashing machine 38, emission of a periodic monitoring signal 90 does not place an unacceptable load on the energy source of the dispenser 2, since the monitoring signals 90 have merely to be received and evaluated during a washing program.

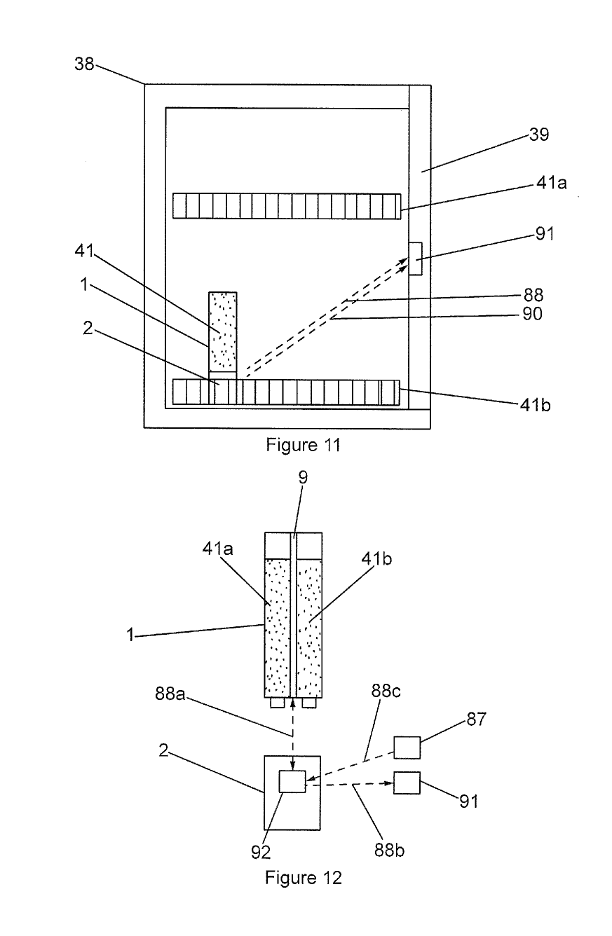

As shown in FIG. 11, it goes without saying that it is also conceivable, if the energy source of the dispenser 2 is adequately dimensioned, for both the monitoring signals 90 and the control signal 88 to be transmitted by the dispenser 2 to a corresponding receive unit 91 in the dishwashing machine 38.

It is in principle also possible for the transmit and receive modes of control and monitoring signals 88, 90 according to FIG. 10 and FIG. 11 to be superimposed on or parallel to one another. This means that a monitoring signal 90 is emitted by the transmit unit 87 and received by the dispensing unit 2 and a control signal 88 is transmitted by the dispensing unit to a receive unit 91.

Another embodiment of the invention is shown in FIG. 12. FIG. 12 shows the dispenser 2, which has an optical transmit and receive unit 92. By means of the optical transmit and receive unit 92, control signals 88b may be transmitted to a receive unit 91 on the dishwashing machine and control signals 88c may be received from a transmit unit 87 on the dishwashing machine. The receive unit 91 on the dishwashing machine and transmit unit 87 on the dishwashing machine are preferably arranged in a combi dispenser, as shown in FIGS. 30-31. In addition, optical signals 88a from the optical transmit and receive unit 92 may be incoupled into the cartridge 1, in particular into the web 9 taking the form of a light guide, and/or outcoupled from the cartridge 1 and received by the optical transmit and receive unit 92.

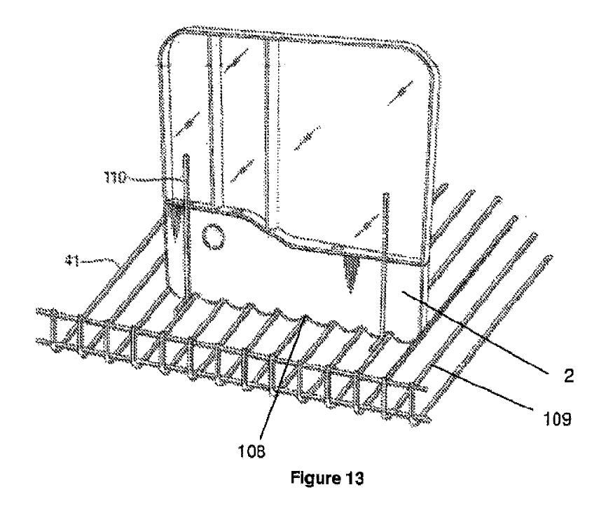

FIG. 13 shows the dispenser 2 coupled with a cartridge 1 in the plate receptacle 110 of a crockery drawer 41. The crockery drawer 41, which is of conventionally grid-like construction, comprises struts 109 in which the fixing means 108 of the dispenser 2 engage. This prevents lateral slippage of the dispenser 2, for example when the crockery drawer 41 is pulled out of or pushed into the dishwasher 38.

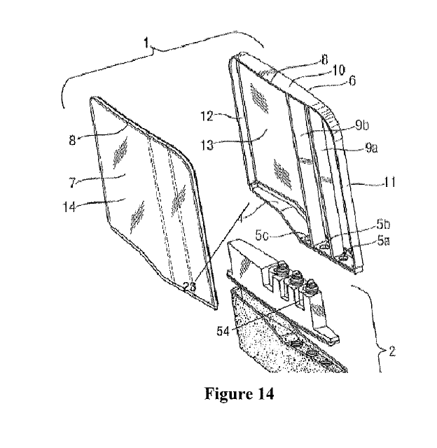

FIG. 14 is an exploded representation of the essential components of the dispensing system consisting of cartridge 1 and dispenser 2.

As may be inferred from FIG. 14, the cartridge 1 is composed of two cartridge elements 6, 7. The dispenser 2 consists substantially of a component carrier 23 and a bracket 54, in which the component carrier 23 may be inserted. In the assembled state, the bracket 54 encloses the component carrier 23 preferably in such a way that water is prevented from penetrating the component carrier 23.

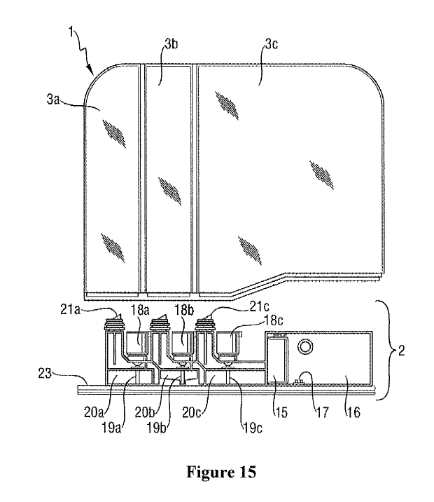

FIG. 15 shows a side view of an embodiment of the component carrier 23 of the dispenser 2, which is explained in greater detail below.

The dispensing chamber 20, the actuator 18 and the closing element 19 are arranged on the component carrier 23, together with the energy source 15, the control unit 16 and the sensor unit 17. The dispensing chamber 20, the predispensing chamber 26, the dispensing chamber inlet 21 and the receptacle 29 are formed in a single part with the component carrier 23.

As may also be inferred from FIG. 15, the energy source 15, the control unit 16 and the sensor unit 17 are combined in an assembly by arranging them on a corresponding board.

As shown in FIG. 15, the predispensing chamber 26 and the actuator 18 are arranged substantially next to one another on the component carrier 23. The predispensing chamber 26 has an L-shaped basic shape with a shoulder in the lower region, into which is set the receptacle 29 for the actuator 18. The outlet chamber 27 is arranged beneath the predispensing chamber 26 and the actuator 18. The predispensing chamber 26 and the outlet chamber 27 together form the dispensing chamber 20.

The predispensing chamber 26 and the outlet chamber 27 are connected together by the orifice 34. The receptacle 29, the orifice 34 and the dispensing chamber outlet 22 lie in a row perpendicular to the longitudinal axis of the component carrier 23, such that the rod-shaped closing element 19 may be guided through the orifices 22, 29, 34.

As is apparent in particular from FIG. 15, the rear walls of the predispensing chamber 26 and the outlet chamber 27 are formed integrally with the component carrier 23. The front wall may then for example be bonded to the dispensing chamber 20 for example by a covering element or a film/foil (not shown).

### Cartridge

For the purposes of the present application, a cartridge is understood to be a packaging means which is suitable for enclosing or holding together at least one flowable, pourable or sprinklable preparation and is couplable to a dispenser for release of at least one preparation.

In the simplest conceivable embodiment, the cartridge comprises a single, preferably dimensionally stable, chamber for storing a preparation. In particular, a cartridge may also comprise a plurality of chambers which may be filled with different compositions.

It is advantageous for the cartridge to comprise at least one outlet orifice which is arranged such that gravity-actuated release of preparation from the cartridge may be brought about in the service position of the dispenser. In this way, no further conveying means are required for release of preparation from the cartridge, whereby the structure of the dispenser may be kept simple and manufacturing costs low. Moreover, it is possible to dispense with the use of conveying means, such as for example pumps, whereby the service life of a battery or storage battery of the dispenser may be increased.

In a preferred development of the invention, at least one second chamber is provided for accommodating at least one second flowable or sprinklable preparation, the second chamber comprising at least one outlet orifice which is arranged such that gravity-actuated product release from the second chamber may be brought about in the service position of the dispenser. The arrangement of a second chamber is particularly advantageous when preparations are stored in the mutually separate chambers of the cartridge which are not conventionally stable in storage together, such as for example bleaching agents and enzymes.

It is also conceivable for more than two, in particular three to four chambers to be provided in or on a cartridge. In particular, one of the chambers may be designed to release volatile preparations such as for instance a scent into the surrounding environment.

A dispensing chamber may be constructed in or on a chamber upstream of a chamber's outlet orifice in the gravity-actuated direction of flow of the preparation. The dispensing chamber determines the quantity of preparation which, on release of preparation from the chamber, is to be released into the surrounding environment. This is particularly advantageous if the closing element of the dispenser, which effects release of the preparation from a chamber into the surrounding environment, may only be put in a release state and a closed state without the quantity released being measured or monitored. The dispensing chamber then ensures that a predefined quantity of preparation is released without direct feedback of the outflowing quantity of preparation currently being released.

The cartridge may be of any desired three-dimensional shape. It may for example be cubic, spherical or plate-like in form.

When using the dispenser in dishwashing machines, it is particularly advantageous to shape the device on the basis of the dishes to be cleaned in dishwashing machines. It may, for example, be plate-shaped, approximately assuming the dimensions of a plate. In this way, the dispenser may be positioned in space-saving manner for example in the lower basket of the dishwasher. Furthermore, the correct positioning of the dispensing unit is immediately obvious to the user thanks to the plate-like shape.

In the coupled state, the dispenser and cartridge preferably have a ratio of height:width:depth of between 5:5:1 and 50:50:1, particularly preferably of around 10:10:1. Due to the “slender” construction of the dispenser and the cartridge it is in particular possible to position the device in the lower basket of a dishwashing machine in the receptacles provided for plates. This has the advantage that the preparations released from the dispenser pass directly into the washing liquor and cannot adhere to other items being washed.

Conventional commercial domestic dishwashing machines are usually designed such that larger items to be washed, such as for instance pans or large plates, are arranged in the lower basket of the dishwashing machine. In order to prevent the user from positioning the dispensing system consisting of the dispenser and the cartridge coupled with the dispenser less than ideally in the upper basket, in an advantageous development of the invention the dispensing system is dimensioned such that the dispensing system may only be positioned in the receptacles provided for this purpose in the lower basket. To this end, the width and height of the dispensing system may in particular be selected between 150 mm and 300 mm, particularly preferably between 175 mm and 250 mm.

It is, however, also conceivable to construct the dispensing unit in a cup or pot shape with a substantially circular or square base area.

In a preferred embodiment of the invention, the cartridge comprises an RFID label which at least contains information about the contents of the cartridge and is readable by a sensor unit which may in particular be provided in the dispenser or dishwashing machine.

This information may, for example, be used in order to select a dispensing program stored in the control unit of the dispenser. In this way it may be ensured that the ideal dispensing program is always used for a specific preparation. It may also be provided that, in the absence of an RFID label or in the case of an RFID label with an incorrect or defective ID, the dispensing device does not dispense but instead an optical or acoustic signal is produced which notifies the user of the error.

In order to prevent misuse of the cartridge, the cartridges may also comprise structural elements which interact with corresponding elements of the dispenser like a key in a lock, such that for example only cartridges of a particular type are couplable to the dispenser. This development furthermore makes it possible for information about the cartridge coupled to the dispenser to be transmitted to the control unit of the dispenser, whereby the dispensing device may be controlled in a manner adapted to the contents of the corresponding container.

The cartridge is in particular constructed to accommodate flowable washing or cleaning agents. Such a cartridge particularly preferably comprises a plurality of chambers for spatially separately accommodating in each case different preparations of a washing or cleaning agent. By way of non-exhaustive example, some possible combinations for filling the chambers with different preparations are listed below:

| | Chamber 1 | Chamber 2 | Chamber 3 | Chamber 4 |
|---|---|---|---|---|
| A | Alkaline cleaning | Enzymatic cleaning | — | — |
| | preparation | preparation | | |
| B | Alkaline cleaning | Enzymatic cleaning | Rinse aid | — |
| | preparation | preparation | | |
| C | Alkaline cleaning | Enzymatic cleaning | Rinse aid | Scent |
| | preparation | preparation | | |
| D | Alkaline cleaning | Enzymatic cleaning | Rinse aid | Disinfectant |
| | preparation | preparation | | preparation |
| E | Alkaline cleaning | Enzymatic cleaning | Rinse aid | Pretreatment |
| | preparation | preparation | | preparation |

It is particularly preferred for all preparations to be flowable, since this ensures rapid dissolution of the preparations in the washing liquor of the dishwasher, as a result of which these preparations have a rapid to immediate cleaning or rinsing action, in particular also on the walls of the washing compartment and/or of a light guide of the cartridge and/or of the dispenser.

The cartridge conventionally has a total capacity of <5000 ml, in particular <1000 ml, preferably <500 ml, particularly preferably <250 ml, very particularly preferably <50 ml.

The chambers of a cartridge may be of identical or different capacities. In a configuration with two chambers, the ratio of the chamber volumes is preferably 5:1; in a configuration with three chambers preferably 4:1:1, these configurations in particular being suitable for use in dishwashing machines.

As mentioned above, the cartridge preferably has three chambers. When such a cartridge is used in a dishwashing machine, it is particularly preferred for one chamber to contain an alkaline cleaning preparation, another chamber a enzymatic preparation and a third chamber a rinse aid, the volume ratio of the chambers amounting to approximately 4:1:1.

The chamber containing the alkaline cleaning preparation preferably has the greatest capacity of the chambers present. The chambers which store an enzymatic preparation or a rinse aid preferably have approximately identical capacities.

In a two and/or three chamber configuration of the cartridge, it is in particular possible to store in particular a scent, disinfectant and/or pretreatment preparation in a further chamber arranged detachably on the cartridge or on the dispenser.

The cartridge comprises a cartridge bottom, which in the service position is directed downwards in the direction of gravity and in which, preferably for each chamber, there is provided at least one outlet orifice arranged at the bottom in the direction of gravity. The outlet orifices arranged at the bottom are in particular constructed such that at least one, preferably all of the outlet orifices may be connected in communicating manner with the inlet orifices of the dispenser, such that preparation can flow out of the cartridge via the outlet orifices into the dispenser, preferably under the action of gravity.

It is also conceivable for one or more chambers to comprise an outlet orifice which is not arranged at the bottom in the direction of gravity. This is in particular advantageous when for example a scent is to be released into the surrounding environment of the cartridge.

In a preferred embodiment of the invention, the cartridge for coupling with a dispenser for releasing at least one washing and/or cleaning agent preparation from the cartridge into the interior of a domestic appliance comprises a light guide arranged in or on the cartridge, into which light guide a light signal may be incoupled from outside the cartridge. It is particularly preferred to incouple a light signal which is emitted from the dispenser into the cartridge.

The light guide may in particular be formed entirely or in part in or on the walls and/or webs of the cartridge. It is furthermore advantageous to provide the light guide integrally in or on the walls and/or webs of the cartridge. The light guide preferably consists of a transparent plastics material. It is, however, also possible to make the entire cartridge from a transparent material.

It is preferred for the light guide to be suitable to conduct light in the visible range (380-780 nm). It is particularly preferable for the light guide to be suitable to conduct light in the near infrared range (780 nm-3000 nm). In particular, it is preferred for the light guide to be suitable to conduct light in the mid infrared range (3.0 μm-50 μm).

The light guide in particular consists of a transparent plastics material with an elevated refractive index.

Advantageously, the light guide is entirely or partially enclosed at least in portions by a material with a lower optical refractive index. In particular, the material of the lower optical refractive index may be a preparation stored in a cartridge chamber.

A ratio of the refractive indices of the preparation and light guide of 1:1.10-1:5, preferably of 1:1.15-1:1.35, particularly preferably of 1:1.15-1:1.20 has proved particularly advantageous, the refractive index in each case being determined at a wavelength of 589 nm. The refractive index of the light guide may for example be determined to DIN EN ISO 489. The refractive index of the preparation may be determined by means of a Abbe refractometer to DIN 53491.

It is in particular advantageous for the preparation which entirely or partially encloses the light guide to have a transmittance of 45%-95%, particularly preferably of 60%-90%, very particularly preferably of 75%-85%. The light guide preferably has a transmittance of >75%, very particularly preferably of >85%. Transmittance may be determined to DIN 5036.

It is furthermore preferred for the wavelength of the light which is transmitted through the light guide approximately to correspond to the wavelength of at least one preparation which encloses the light guide at least in portions, which is not absorbed from the visible spectrum by the preparation. It is here particularly preferred for the wavelength of the light which is transmitted through the light guide and the wavelength which is not absorbed by the preparation to be between 600-800 nm.

The light signal incouplable into the light guide in particular bears information, in particular for example with regard to the operating state of the dispenser and/or the filling level of the cartridge.

In a further development of the invention which is to be preferred, the light guide is constructed such that the light signal incouplable into the light guide is also outcouplable again from the light guide.

It may here be advantageous for the light guide to be constructed such that the light signal is outcouplable at a point on the cartridge which is different from the point at which the light signal may be incoupled into the cartridge.

Incoupling and outcoupling of the light signal may in particular be carried out at a prismatically constructed edge of the cartridge.

It is particularly preferred to form incoupling or outcoupling points for the light signal in the corresponding injection mold by highly polished or hard chromium plated tool surfaces such that the reflectivity of the incoupling or outcoupling point is low and the desired signal incoupling is possible.

The distance from the light source, in particular an LED, arranged in the dispenser to the light incoupling point into the cartridge in the coupled state of the cartridge and dispenser should be kept as small as possible.

It is also advantageous for the light signal and the light guide to be configured such that a light signal visible to a user may be generated on and/or in the cartridge.

### Dispenser

The control unit necessary for operation and at least one actuator are integrated into the dispenser. A sensor unit and/or an energy source is preferably likewise arranged on or in the dispenser.

The dispenser preferably consists of a housing protected from water splashing, which prevents penetration of water splashes, as may for example occur during use in a dishwashing machine, into the interior of the dispenser, in which dispenser are arranged at least the control unit, sensor unit and/or actuator.

It is particularly advantageous to encapsulate in particular the energy source, the control unit and the sensor unit in such a manner that the dispenser is substantially water-tight, i.e. the dispenser is functional even when completely immersed in liquid. Examples of encapsulation materials which may be used are multi-component epoxide and acrylate encapsulation compounds such as methacrylate esters, urethane meth- and cyanoacrylates or two-component materials comprising polyurethanes, silicones, epoxy resins.

An alternative or supplement to encapsulation is enclosing the components in an appropriately designed, moisture-tight housing. Such a development is further explained in greater detail below.

It is furthermore advantageous to arrange the components or assemblies on and/or in a component carrier in the dispenser; this too is further explained elsewhere.

It is furthermore advantageous for the material from which the dispenser is shaped to prevent or at least reduce biofilm growth. This may be achieved by using appropriate surface textures of the material or additives, such as for example biocides, known from the prior art. It is also conceivable to provide some areas of the dispenser at risk of microbial growth, in particular those areas in which washing water can accumulate, with a finish which prevents or at least reduces biofilm growth. Films/foils with an appropriate action may for example be used for this purpose.

It is particularly preferred for the dispenser to comprise at least one first interface which interacts with a corresponding interface provided in or on a domestic appliance, in particular a water-conveying domestic appliance, preferably a dishwashing or washing machine, such that electrical energy and/or signals is/are transmitted from the domestic appliance to the dispenser and/or from the dispenser to the domestic appliance.

In one development of the invention, the interfaces take the form of plug-in connectors. In a further development, the interfaces may be constructed such that electrical energy and/or electrical and/or optical signals are transmitted wirelessly.

It is here particularly preferred for the interfaces provided for transmitting electrical energy to be inductive transmitters and receivers of electromagnetic waves. The interface of a water-conveying appliance, such as for instance a dishwashing machine, may accordingly in particular be configured as an AC-operated transmitter coil with an iron core and the dispenser interface may be configured as a receiver coil with an iron core.

In an alternative embodiment, the transmission of electrical energy may also be provided by means of an interface which comprises, on the domestic appliance side, an electrically operated light source and, on the dispenser side, a light sensor, for example a photodiode or a solar cell. The light emitted by the light source is converted into electricity in the light sensor, which is then in turn stored, for example, by a storage battery on the dispenser side.

In an advantageous further development of the invention, an interface is provided on the dispenser and the water-conveying appliance, such as for instance a dishwashing machine, for transferring (i.e. transmitting and receiving) electromagnetic and/or optical signals, which in particular represent operating state, measurement and/or control information of the dispenser and/or of the water-conveying equipment such as a dishwashing machine.

It is, of course, possible only to provide an interface for transmitting signals or an interface for transmitting electrical energy or in each case to provide an interface for transmitting signals and an interface for transmitting electrical energy or to provide an interface with is suitable for transmitting both electrical energy and signals.

Such an interface may in particular be constructed such that electrical energy and/or electromagnetic and/or optical signals is/are transmitted wirelessly.

It is particularly preferred for the interface to be configured for emitting and/or receiving optical signals. It is very particularly preferred for the interface to be configured to emit or receive light in the visible range. Since conventionally when a dishwashing machine is in operation it is dark inside the washing compartment, signals may be emitted and/or detected by the dispenser in the visible optical range, for example in the form of signal pulses or photoflashes. It has proved particularly advantageous to use wavelengths of between 600-800 nm in the visible spectrum.

Alternatively or in addition, it is advantageous for the interface to be configured to emit or receive infrared signals. It is particularly advantageous for the interface to be configured to emit or receive infrared signals in the near infrared range (780 nm-3000 nm).

In particular, the interface comprises at least one LED. Particularly preferably, the interface comprises at least two LEDs. It is also possible according to a further preferred development of the invention to provide at least two LEDs, which emit light at different wavelengths. This makes it possible, for example, to define different signal bands on which information may respectively be transmitted or received.

In addition, it is advantageous, in a further development of the invention, for at least one LED to be an RGB LED, the wavelength of which is adjustable. Thus, for example, different signal bands which emit signals on different wavelengths may be defined with one LED. It is thus for example also conceivable for light to be emitted on a different wavelength during the drying process, during which high atmospheric humidity (fog) prevails in the washing compartment, than for example during a washing stage.

The interface of the dispenser may be configured in such a way that the LED is provided both for emitting signals inside the dishwasher, in particular when the dishwashing machine door is closed, and for optical display of an operating state, in particular when the dishwashing machine door is open.

It is particularly preferable for an optical signal to be configured as a signal pulse with a pulse duration of between 1 ms and 10 seconds, preferably between 5 ms and 100 ms.

In addition, it is advantageous for the interface of the dispenser to be configured in such a way that it emits an optical signal with the dishwashing machine closed and unloaded which brings about an average illuminance E of between 0.01 and 100 lux, preferably between 0.1 and 50 lux, measured at the walls bounding the washing compartment. This illuminance is then sufficient to bring about multiple reflections with or at the other washing compartment walls and thus to reduce or prevent possible signal shadows in the washing compartment, in particular when the dishwashing machine is loaded.

The signal emitted and/or received by the interface in particular bears information, in particular being a control signal or a signal which represents an operating state of the dispenser and/or of the dishwasher.

In an advantageous further development of the invention, the dispenser for releasing at least one washing and/or cleaning agent preparation from a cartridge into the interior of a domestic appliance comprises a light source, by means of which a light signal may be incoupled into a light guide of the cartridge. The light source may in particular be an LED. This for example makes it possible to incouple light signals, for example representing the operating state of the dispenser, from the dispenser into the cartridge, such that said signals are visually perceptible on the cartridge by a user. This is in particular advantageous because, in the service position in the plate receptacle of a crockery drawer in a dishwasher, the dispenser may be visually concealed between other items to be washed. By incoupling the light from dispenser into the cartridge, the corresponding light signals may for example also be guided into the top zone of the cartridge, such that, even if the dispenser is positioned in the plate receptacle between other items to be washed, the light signals are visually perceptible by the user since, if the crockery drawer is properly loaded, the top zones of the items to be washed and of the cartridge conventionally remain uncovered.

It is furthermore possible for the light signal incoupled into and passing through the light guide of the cartridge to be detectable by a sensor located on the dispenser. This is explained in greater detail in the following section.

In a further, advantageous development, the dispenser for releasing at least one washing and/or cleaning agent preparation into the interior of a domestic appliance comprises at least one optical transmit unit, the optical transmit unit being configured such that signals from the transmit unit may be incoupled into a cartridge couplable with the dispenser and signals from the transmit unit may be emitted into the surrounding environment of the dispenser. In this way, it is possible by means of an optical transmit unit to achieve not only signal transmission between the dispenser and for example a domestic appliance such as a dishwashing machine but also signal input into a cartridge.

In particular, the optical transmit unit may be an LED which preferably emits light in the visible and/or IR range. It is also conceivable to use another suitable optical transmit unit, such as for example a laser diode. It is particularly to be preferred to use optical transmit units, which emit light in the wavelength range between 600-800 nm.

In an advantageous further development of the invention the dispenser may comprise at least one optical receive unit. This for example makes it possible for the dispenser to receive signals from an optical transmit unit arranged in the domestic appliance. This may be achieved by any suitable optical receive unit, such as for example photocells, photomultipliers, semiconductor detectors, photodiodes, photoresistors, solar cells, phototransistors, CCD and/or CMOS image sensors. It is particularly preferred for the optical receive unit to be suitable for receiving light in the wavelength range from 600-800 nm.

In particular, the optical receive unit on the dispenser may also be constructed such that the signals from the transmit unit incouplable into a cartridge coupled with the dispenser are outcouplable from the cartridge and are detectable by the optical receive unit of the dispenser.

The signals emitted by the transmit unit into the surrounding environment of the dispenser may preferably represent information with regard to operating states or control commands.

### Component Carrier

The dispenser comprises a component carrier on which are arranged at least the actuator and the closing element and the energy source and/or the control unit and/or the sensor unit and/or the dispensing chamber.

The component carrier comprises receptacles for the stated components and/or the components are shaped in a single part with the component carrier.

The receptacles for the components in the component carrier may be provided for a frictional, interlocking and/or bonded connection between a corresponding component and the corresponding receptacle.

For the purposes of simple demounting of the components from the component carrier, it is furthermore conceivable for the dispensing chamber, the actuator, the closing element, the energy source, the control unit and/or the sensor unit in each case to be detachably arranged on the component carrier.

It is also advantageous for the energy source, the control unit and the sensor unit to be arranged as a combined assembly on or in the component carrier. In an advantageous further development of the invention, the energy source, the control unit and the sensor unit are combined as an assembly. This may for example be achieved by arranging the energy source, the control unit and the sensor unit on a common electrical printed circuit board.

The component carrier ensures maximally straightforward automatic population of the dispenser with the necessary components. The component carrier may in this way be preassembled preferably automatically in its entirety and assembled to form a dispenser.

According to one embodiment of the invention, once populated, the trough-like component carrier may be closed in liquid-tight manner with a, for example, lid-like closing element. The closing element may for example take the form of a film/foil which is bonded in liquid-tight manner with the component carrier and, with the trough-like component carrier, forms one or more liquid-tight chambers.

The closing element may also be a bracket, into which the component carrier may be introduced, wherein, when in the assembled state, the bracket and the component carrier form the dispenser. When in the assembled state, the component carrier and the bracket interact such that a liquid-tight connection is formed between the component carrier and the bracket, such that no washing water can get into the interior of the dispenser or of the component carrier.

In the service position of the dispenser, it is furthermore preferred for the receptacle for the actuator on the component carrier to be arranged above the dispensing chamber in the direction of gravity, whereby a compact structure of the dispenser may be achieved. The compact design may be further optimized by arranging the dispensing chamber inlet on the component carrier above the receptacle of the actuator in the service position of the dispenser. It is also to be preferred for the components on the component carrier to be arranged substantially in a row relative to one another, in particular along the longitudinal axis of the component carrier.

In a further development of the invention, the receptacle for the actuator comprises an orifice which is in line with the dispensing chamber outlet, such that a closing element may be moved to and fro by the actuator through the orifice and the dispensing chamber outlet.

It is particularly preferred for the component carrier to be formed of a transparent material.

The component carrier advantageously comprises at least one light guide, through which light from the surrounding environment of the dispenser may be guided into and/or out of the interior(s) of the dispenser or of the component carrier to an optical transmit and/or receive unit, wherein the light guide is in particular shaped in a single-part with the transparent component carrier.

It is accordingly furthermore preferred for at least one orifice to be provided in the dispenser, through which the light from the surrounding environment of the dispenser may be incoupled and/or outcoupled into and/or out of the light guide.

### Actuator

For the purposes of the present application, an actuator is a device which converts an input variable into an output variable of a different kind and with which an object is moved or movement thereof is brought about, the actuator being coupled with at least one closing element such that release of preparation from at least one cartridge chamber may indirectly or directly be effected.

The actuator may be driven by means of drives selected from the group of gravity drives, ion drives, electric drives, motor drives, hydraulic drives, pneumatic drives, gear drives, worm gear drives, ball-screw drives, linear drives, roller-screw drives, toothed worm drives, piezoelectric drives, chain drives, and/or reaction drives.

In particular, the actuator may be constructed from an electric motor which is coupled with a gear train which converts the rotational motion of the motor into a linear motion of a carriage coupled to the gear train. This is in particular advantageous in a slender, plate-shaped configuration of the dispensing unit.

At least one magnet element may be arranged on the actuator, which magnet element, together with a magnet element of identical polarity on a dispenser, effects product release from the container as soon as the two magnet elements are positioned relative to one another such that magnetic repulsion is brought about by the magnetic elements of identical polarity and a contactless release mechanism is created.

In a particularly preferred embodiment of the invention, the actuator is a bistable solenoid which, together with a closing element taking the form of a plunger core engaging in the bistable solenoid, forms a pulse-controlled bistable valve. Bistable solenoids are electromechanical magnets with a linear direction of motion, the plunger core coming to an unenergized rest in each end position.

Bistable solenoids or valves are known from the prior art. In order to change between valve positions (open/closed), a bistable valve requires a pulse and then remains in this position until a counter-pulse is transmitted to the valve. Such a valve is accordingly also known as a pulse-controlled valve. One substantial advantage of such pulse-controlled valves is that they do not consume any energy in order to remain at the valve end positions, the closure position and the release position, but instead merely require an energy pulse to change valve position and the valve end positions should thus be considered stable. A bistable valve remains in whatever switching position for which it most recently received a control signal.

The closing element (plunger core) is driven to one end position for each pulse of electricity. If the power is switched off, the closing element retains its position. The closing element (plunger core) is driven to the other end position for each pulse of electricity. If the power is switched off, the closing element retains its position.

Bistable characteristics of solenoids may be achieved in various ways. On the one hand, it is known to divide the coil. The coil is divided more or less centrally, so creating a gap. A permanent magnet is inserted into this gap. The plunger core itself has material removed from it by lathe from both front and rear such that, in each end position, it has a planar face relative to the magnet frame. The magnetic field of the permanent magnet flows through this face. The plunger core sticks here. Alternatively, it is also possible to use two separate coils. The principle is similar to the bistable solenoid with a divided coil. The difference is that there actually are two different electrical coils. These are separately driven depending on the direction in which the plunger core is to be moved.

### Closing Element

A closing element for the purposes of the present application is a component on which the actuator acts and which, as a consequence of said action, brings about opening or closing of an outlet orifice.

The closing element may, for example, comprise valves which may be adjusted by the actuator into a product release position or a closure position.

It is particularly preferred for the closing element and the actuator to assume the form of a solenoid valve, in which the dispenser is embodied by the valve and the actuator by the electromagnetic or piezoelectric drive of the solenoid valve. In particular when a plurality of containers and thus of preparations to be dispensed are used, the use of solenoid valves permits very precise control of the quantity and timing of dispensing.

It is therefore advantageous to control the release of preparations from each outlet orifice of a chamber with a solenoid valve such that the solenoid valve indirectly or directly determines the release of preparation from the product release orifice.

### Sensor

For the purposes of the present application, a sensor is a measured variable pickup or detecting element, which may qualitatively or quantitatively detect specific physical or chemical properties and/or the material nature of its surrounding environment as a measured variable.

The dispensing unit preferably comprises at least one sensor, which is suitable for detecting a temperature. The temperature sensor is designed in particular to detect a water temperature.

It is additionally preferred for the dispensing unit to comprise a sensor for detecting conductivity, whereby in particular the presence of water or the spraying of water, in particular in a dishwashing machine, is detected.

In a further development of the invention the dispensing unit comprises a sensor, which may determine physical, chemical and/or mechanical parameters from the surrounding environment of the dispensing unit. The sensor unit may comprise one or more active and/or passive sensors for the qualitative and/or quantitative detection of mechanical, electrical, physical and/or chemical variables which are forwarded to the control unit as control signals.

In particular, the sensors of the sensor unit may be selected from the group of timers, temperature sensors, infrared sensors, brightness sensors, temperature sensors, motion sensors, strain sensors, rotational speed sensors, proximity sensors, flow sensors, color sensors, gas sensors, vibration sensors, pressure sensors, conductivity sensors, turbidity sensors, instantaneous acoustic pressure sensors, “lab-on-a-chip” sensors, force sensors, acceleration sensors, inclination sensors, pH sensors, moisture sensors, magnetic field sensors, RFID sensors, magnetic field sensors, Hall sensors, biochips, odor sensors, hydrogen sulfide sensors and/or MEMS sensors.

In particular in the case of preparations whose viscosity is subject to severe temperature-dependent fluctuation, it is advantageous to provide flow sensors in the dispensing device for monitoring the volume or mass of the dispensed preparations. Suitable flow sensors may be selected from the group of diaphragm flow sensors, magnetic-inductive flow meters, mass flow metering using the Coriolis method, eddy flow metering, ultrasound flow metering, rotameter metering, annular piston flow metering, thermal mass flow metering or differential pressure flow metering.

It is particularly preferable for at least two sensor units to be provided for measuring different parameters, one sensor unit very particularly preferably being a conductivity sensor and a further sensor unit very particularly preferably being a temperature sensor. It is additionally preferable for at least one sensor unit to be a brightness sensor.

The sensors are in particular adjusted for detecting the start, progress and end of a washing program. By way of non-exhaustive examples, the sensor combinations listed in the following table may be used for this purpose:

| Sensor 1 | Sensor 2 | Sensor 3 | Sensor 4 |
|---|---|---|---|
| Conductivity | Temperature sensor | | |
| sensor | | | |
| Conductivity | Temperature sensor | Brightness sensor | |
| sensor | | | |
| Conductivity | Temperature sensor | Brightness sensor | Turbidity sensor |
| sensor | | | |
| Acoustic | Temperature sensor | | |
| sensor | | | |

Using the conductivity sensor, it is possible, for example, to detect whether the conductivity sensor has been wetted with water, such that it may for example thereby be established whether there is water in the dishwashing machine.

Washing programs as a rule exhibit a characteristic temperature profile, which is determined inter alia by the heating of the washing water and drying of the items being washed, and which may be detected using a temperature sensor.

A brightness sensor may be used, for example, to detect the incidence of light into the interior of a dishwasher when the dishwashing machine door is opened, from which it may for example be concluded that the washing program has come to an end.

A turbidity sensor may also be provided to determine the degree of soiling of the items to be washed in the dishwasher. This for example also allows selection of a dispenser dispensing program which is appropriate for the identified soiling situation.

It is also feasible to detect the progress of a washing program with the assistance of at least one acoustic sensor, specific sound and/or vibration emissions being detected, for example when water is pumped in or out.

It goes without saying that it is possible for a person skilled in the art to use any desired, suitable combinations of a number of sensors to achieve washing program monitoring.

The data line between sensor and control unit may take the form of an electrically conductive cable or may assume a cable-less form. In principle it is also conceivable for at least one sensor to be positioned or positionable outside the dispenser in the interior of a dishwashing machine and for a data line, in particular a cable-less data line, to be provided for transmitting measured data from the sensor to the dispenser.

A cable-less data line is achieved in particular by the transmission of electromagnetic waves or light. It is preferable for a cable-less data line to be configured to standards such as for example Bluetooth, IrDA, IEEE 802, GSM, UMTS etc.

To allow efficient production and assembly of the dispenser, it is also possible, however, for at least one sensor unit to be arranged on or in the control unit. For example, it is possible to provide a temperature sensor in the dispenser or directly on the board bearing the control unit, such that the temperature sensor does not have any direct contact with the surrounding environment.

### Control Unit

A control unit for the purposes of the present application is a device which is suitable for influencing the transport of material, energy and/or information. To this end, the control unit acts on actuators with the assistance of information, in particular sensor unit measurement signals, which it processes for the purposes of the control objective.

The control unit may in particular comprise a programmable microprocessor. In a particularly preferred embodiment of the invention, a plurality of dispensing programs are stored in the microprocessor which in a particularly preferred configuration may be selected and executed depending on the container coupled to the dispenser.

In a preferred embodiment, the control unit is not connected to any controller which may be present in the domestic appliance. Accordingly, no information, in particular electrical, optical or electromagnetic signals, is exchanged directly between the control unit and the controller of the domestic appliance.

In an alternative development of the invention the control unit is coupled to the existing controller of the domestic appliance. This coupling is preferably cable-less. It is possible, for example, to position a transmitter on or in a dishwashing machine, preferably on or at the dispensing chamber set into the door of the dishwashing machine, which transmits a signal wirelessly to the dispensing unit if the controller of the domestic appliance brings about dispensing for example of a cleaning agent from the dispensing chamber or of rinse aid.

A plurality of programs for the release of different preparations or for the release of products in different instances of use may be stored in the control unit.

In a preferred development of the invention, the appropriate program is called by corresponding RFID labels or geometric information media formed on the container. It is thus for example possible to use the same control unit for a plurality of applications, for example for dispensing cleaning agents in dishwashing machines, for releasing perfumes for room fragrancing, for applying cleaning substances to a toilet bowl etc.

In order to dispense preparations which in particular have a tendency towards gelation, the control unit may be configured in such a way that on the one hand dispensing takes place in a sufficiently short time to ensure a good cleaning result and on the other hand the preparation is not dispensed so quickly that the spurt of preparation gels. This may be effected for example by release at intervals, the individual dispensing intervals being adjusted in such a way that the correspondingly dispensed quantities dissolve completely during a cleaning cycle.

It is particularly preferable for the dispensing intervals for releasing a preparation to be between 30-90 sec, particularly preferably 45-75 sec.

Release of preparations from the dispenser may proceed in sequence or at the same time.

It is particularly preferable to dispense a plurality of preparations in sequence in a washing program. The following dispensing sequences are particularly preferable

| 1st dispensing | 2nd dispensing | 3rd dispensing | 4th dispensing |
|---|---|---|---|
| Enzymatic | Alkaline cleaning | | |
| cleaning | preparation | | |
| preparation | | | |
| Alkaline cleaning | Rinse aid | | |
| preparation | | | |
| Enzymatic | Alkaline cleaning | Rinse aid | |
| cleaning | preparation | | |
| preparation | | | |
| Enzymatic | Alkaline cleaning | Rinse aid | Disinfectant |
| cleaning | preparation | | preparation |
| preparation | | | |
| Enzymatic | Alkaline cleaning | Rinse aid | Scent |
| cleaning | preparation | | |
| preparation | | | |
| Pretreatment | Enzymatic | Alkaline cleaning | Rinse aid |
| preparation | cleaning | preparation | |
| | preparation | | |

According to a particularly preferred embodiment of the invention, the dishwashing machine and the dispenser interact in such a way that 1 mg to 1 g of surfactant are released in the rinse program of the dishwashing machine per m² of washing compartment wall area. In this way it is ensured that the walls of the washing compartment retain their degree of gloss even after a large number of washing cycles and the dispensing system retains its optical transmission capacity.

It is additionally advantageous for the dishwashing machine and the dispenser to interact in such a way that in the prewash and/or main wash program of the dishwashing machine at least one enzyme-containing preparation and/or alkaline preparation is released, the enzyme-containing preparation preferably being released before the alkaline preparation.

In a further, advantageous development of the invention, the dishwashing machine and dispenser interact in such a way that 0.1 mg-250 mg of enzyme protein are released in the prewash and/or main wash program of the dishwashing machine per m² of washing compartment wall area, whereby the degree of gloss of the washing compartment walls is further improved or is maintained even after a plurality of washing cycles.

In an advantageous further development of the invention, data such as for example control and/or dispensing programs of the control unit or operating parameters or protocols stored by the control unit may be read out of the control unit or loaded into the control unit. This may be performed for example by means of an optical interface, wherein the optical interface is connected appropriately to the control unit. The data to be transmitted are then encoded as light signals, in particular in the visible range, the wavelength range between 600-800 nm being preferred, and emitted or received. It is also possible, however, to use a sensor present in the dispenser for transmitting data from and/or to the control unit. For example, the contacts of a conductivity sensor, which are connected to the control unit and which provides conductivity determination by means of resistance measurement at the contacts of the conductivity sensor, are used for data transmission.

By means of the control unit, a method may in particular be developed for operating a dispenser not firmly connected to a domestic appliance for release of at least one washing and/or cleaning agent preparation into the interior of the domestic appliance, wherein at least one dispensing program is stored in the control unit, and the control unit cooperates with at least one actuator located in the dispenser in such a way that washing and/or cleaning agent preparation may be released by the dispenser into the interior of the domestic appliance, the dispenser comprises at least one receive unit for signals, which are emitted by at least one transmit unit arranged in the domestic appliance and at least some of the signals are converted in the dispenser-side control unit into control commands for the actuators of the dispenser, wherein reception of the signals on the dispenser side is monitored by means of the control unit and a dispensing program from the control unit of the dispenser is activated if the signals are not received at the dispenser.

This makes it possible for preparation dispensing to be ensured in the event of an interruption to the signals between the transmit unit on the domestic appliance and the dispenser, the dispenser handing over overall control from the domestic appliance to the controller inside the dispenser.

In particular, it is advantageous for the domestic appliance-side signal to be emitted at predefined periodic intervals by the transmit unit on the domestic appliance into the interior of the domestic appliance. This makes it possible for the defined, periodic intervals at which a signal is output by the transmit unit on the domestic appliance to be saved in the control unit of the dispenser as well as in the domestic appliance. If contact between the transmit unit of the domestic appliance is interrupted after reception of a signal at the dispenser, this interruption may be identified at the dispenser by comparing the time that has elapsed since the last received signal and the time at which reception of a subsequent signal is expected according to the defined, periodic time interval.

It is preferable for the periodic signal intervals to be selected as between 1 sec and 10 min, preferably between 5 sec and 7 min, particularly preferably between 10 sec and 5 min. It is very particularly preferable for the periodic signal intervals to be selected as between 3 min and 5 min.

It is therefore particularly advantageous for reception of a signal output by the domestic appliance to be logged in the control unit of the dispenser with time information t₁.

It is very particularly preferred for the control unit of the dispenser to activate a dispensing program from the control unit of the dispenser after elapse of a predefined time interval t₁₋₂ starting at t₁ during which no further domestic appliance-side signal has been received by the dispenser.

According to an advantageous further development of the invention, the control unit evaluates the number and/or sequence of the signals received by the dispenser in such a way that a dispensing program is activated in the control unit in accordance with the evaluation result. This makes it possible for example to determine the duration of a washing program in a dishwashing machine from the start thereof by comparing the time at which the first signal is received with the time at which interruption of the signal is identified, such that, in accordance with the progress of the washing program, a suitable dispensing program is activated in the control unit of the dispenser which corresponds to the progress of the washing program.

It is also conceivable, on the basis of the above-described evaluation of the number and/or sequence of the signals received by the dispenser, for a dispensing program stored in the control unit of the dispenser to be activated in the control unit beginning from a defined program step corresponding to the progress of the washing program. It is thus possible for example, in the event of signal interruption in the main washing cycle of a washing program, to activate a dispensing program in the dispenser which is provided for a main washing cycle and subsequent washing program sections.

In particular, the signals emitted by the transmit unit on the domestic appliance comprise at least one control signal.

In an advantageous further development of the invention, the signals emitted by the transmit unit on the domestic appliance comprise at least one monitoring signal.

Furthermore, it is advantageous for at least one dispensing program stored in the control unit to comprise a domestic appliance dispensing program. This makes it possible for the dispenser to continue a dispensing program begun by the domestic appliance in the event of signal interruption between the domestic appliance and the dispenser.

It is therefore particularly preferable for the dispensing programs stored in the control unit of the dispenser to comprise the dispensing programs of the domestic appliance.

If a signal does not appear at the dispenser, an acoustic and/or optical signal perceptible to a user may advantageously be generated, which indicates the signal interruption.

It may additionally be advantageous for it to be possible for emission of a monitoring signal and/or control signal at the domestic appliance to be effected manually by a user. In this way, a user may for example verify whether signal reception exists between the transmit unit of the domestic appliance and the dispenser when the dispenser is in a position selected by said user inside the domestic appliance. This may be effected for example by operating elements provided on the domestic appliance, such as for example a pushbutton or switch, which emits a monitoring and/or control signal on actuation.

### Energy Source

For the purposes of the present application, an energy source is taken to mean a component of the dispensing device which is capable of providing energy which is suitable for operation of the dispensing system or of the dispenser. The energy source is preferably configured such that the dispensing system is autonomous.

The energy source preferably provides electrical energy. The energy source may for example comprise a battery, a storage battery, a mains energy supply, solar cells or the like.

It is particularly advantageous to make the energy source interchangeable, for example in the form of a replaceable battery.

A battery may for example be selected from the group of alkali-manganese batteries, zinc-carbon batteries, nickel-oxyhydroxide batteries, lithium batteries, lithium-iron sulfide batteries, zinc-air batteries, zinc chloride batteries, mercury oxide-zinc batteries and/or silver oxide-zinc batteries.

Examples of suitable storage batteries are lead storage batteries (lead dioxide/lead), nickel-cadmium storage batteries, nickel-metal hydride storage batteries, lithium-ion storage batteries, lithium-polymer storage batteries, alkali-manganese storage batteries, silver-zinc storage batteries, nickel-hydrogen storage batteries, zinc-bromine storage batteries, sodium-nickel chloride storage batteries and/or nickel-iron storage batteries.

The storage battery may in particular be designed in such a way that it may be rechargeable by induction.

It is however also conceivable to provide mechanical energy sources consisting of one or more helical springs, torsion springs or torsion bars, bending springs, air/gas springs and/or elastomer springs.

The energy source is dimensioned in such a manner that the dispenser may run through approximately 300 dispensing cycles before the energy source is exhausted. It is particularly preferable for the energy source to run through between 1 and 300 dispensing cycles, very particularly preferably between 10 and 300, more preferably between 100 and 300, before the energy source is exhausted.

In addition, means may be provided on the dispensing unit for energy conversion, which generate a voltage by means of which the storage battery is charged. These means may for example take the form of a dynamo, which is driven by the water currents during a washing cycle in a dishwashing machine and outputs the voltage generated in this way to the storage battery.

### Light Guide Dispenser

An optical transmit and/or receive unit is preferably arranged inside the dispenser, in particular in or on the component carrier, in order to protect the electrical and/or optical components of the transmit and/or receive unit from being affected by water splashes and washing water.

To conduct light out of the surrounding environment of the dispenser to the optical transmit and/or receive unit, a light guide is arranged between the optical transmit and/or receive unit and the surrounding environment of the dispenser, which exhibits light transmittance of at least 75%. The light guide preferably consists of a transparent plastics material with a transmittance of at least 75%. The transmittance of the light guide is defined as transmittance between the surface of the light guide at which light is incoupled from the surrounding environment of the dispenser into the light guide and the surface at which light is outcoupled from the light guide to the optical transmit and/or receive unit. Transmittance may be determined to DIN 5036.

The light guide comprises at least one incoupling and/or outcoupling point at which light from an optical transmit and/or receive unit and/or from the surrounding environment of the dispenser is respectively incoupled and outcoupled.

It is particularly preferable for the light guide to be of single-part construction with the component carrier. Advantageously, the component carrier is therefore made from a transparent material.

To accommodate the incoupling and/or outcoupling point of the light guide and produce an optical connection between light guide and surrounding environment, an orifice is provided in the dispenser. The incoupling and/or outcoupling point may be arranged in the outer circumferential surface in the bottom or top of the dispenser. In order to provide a good transmit and/or receive characteristic for optical signals, it may be advantageous for the incoupling and/or outcoupling point of the light guide to be of lenticular and/or prismatic construction.

The light guide may also be of multi-layer and/or multi-part construction of identical or different materials. It is also possible to provide an air gap between a light guide of multi-layer and/or multi-part form. The transmittance of the light guide is understood in the case of multi-layer and/or multi-part structure as being between the surface of the light guide at which light is incoupled from the surrounding environment of the dispenser into the light guide and the surface at which light is outcoupled from the light guide to the optical transmit and/or receive unit.

In addition, it is preferable for at least two incoupling or outcoupling points of the light guide to be provided relative to the surrounding environment. It is particularly advantageous for the incoupling or outcoupling points on the dispenser to be substantially opposite one another.

### Dishwashing Machine

A dishwashing machine suitable for the dispensing system according to the invention in particular comprises a closable washing compartment. Conventionally, the washing compartment of a dishwashing machine is opened and closed by a door or drawer. Conventionally, the washing compartment is protected in this way from the ingress of ambient light.

The walls of the washing compartment have in particular a degree of gloss of at least 10 gloss units, preferably at least 20 gloss units, particularly preferably at least 45 gloss units measured to DIN 67530 with 60° geometry. This enables multiple reflections of the radiated optical signals from the walls of the washing compartment, so reducing the risk of possible signal shadows, in particular for optical signals in the visible and/or IR range in the interior of the washing compartment of the dishwashing machine.

An average degree of gloss means the degree of gloss averaged over the entire surface of a wall. In a particularly preferred development of the invention, the average degree of washing compartment gloss amounts to at least 10 gloss units, preferably at least 20 gloss units, particularly preferably at least 45 gloss units measured to DIN 67530 with 60° geometry.

An average degree of washing compartment gloss means the degree of gloss averaged over the entire surface of all the washing compartment walls. In a particularly preferred development of the invention, the average degree of gloss of the washing compartment walls amounts to at least 10 gloss units, preferably at least 20 gloss units, particularly preferably at least 45 gloss units measured to DIN 67530 with 60° geometry.

To reduce further the risk of signal shadows in the washing compartment, in particular for optical signals in the visible or IR range, it is particularly advantageous for the walls of the washing compartment to exhibit a reflectance of at least 50%.

An average reflectance means the reflectance averaged over the entire surface of a wall. In a particularly preferred development of the invention the average reflectance of the washing compartment walls amounts to at least 50%.

An average washing compartment reflectance means the reflectance averaged over the entire surface of all the washing compartment walls. In a further preferred development of the invention the average washing compartment reflectance amounts to at least 50%.

It is furthermore advantageous, in order to maintain and/or improve the degree of gloss of the washing chamber walls, for at least one surfactant, at least one polymer, and at least one phosphonate to be released from one or more preparations into the washing liquor, these components being selected so that at least the surfactant and the polymer adhere onto that surface of the light guide which is directed into the washing compartment. Improved runoff and drying of washing liquid on the walls is thereby achieved, with the result that deposits on the walls, e.g. in the form of water spots, are decreased. In addition, the surfactants and/or polymers adhering to the walls represent a kind of sealant for the wall surfaces, so that new deposits of foreign substances can be decreased.

In a preferred development of the invention the walls of the washing compartment comprise optical reflection elements. The reflection elements serve in distributing the optical signals as homogeneously as possible in particular in the visible and/or IR range within the washing compartment, such that zones of optical signal shadows within the washing compartment may be reduced or completely avoided by the corresponding reflections. It is particularly preferable for the reflection elements to be formed integrally with the washing compartment walls. According to an advantageous development the optical reflection elements project out of the plane of the washing compartment walls and into the washing compartment. It is also conceivable, however, for the optical reflection elements to take the form of recesses in the washing compartment walls. The optical reflection elements may assume any suitable three-dimensional shape, in particular the optical reflection elements are for example dome-shaped, bowl-shaped, truncated cone-shaped, cuboidal or cubic, with rounded or sharp edges and/or consist of combinations of the above.

The reflection elements may in particular be arranged approximately centrally on a washing compartment wall. However, it is also conceivable additionally or alternatively to provide reflection elements at the edges or corners of a washing compartment wall, in order to reduce the risk of signal shadows in particular in the rear, lower and upper corners of the washing compartment (when viewed from the dishwashing machine door).

### Release Device for the Dishwasher

In a preferred embodiment of the invention the dispenser may receive signals from a release device fixed in a dishwashing machine.

The release device for releasing at least one preparation into the interior of a dishwasher may in particular be a cleaning agent dispenser, a release device for rinse aid or salt or a combi dispenser.

The release device advantageously comprises at least one transmit unit and/or at least one receive unit for wireless transmission of signals into the interior of the dishwasher or for wireless reception of signals from the interior of the dishwasher.

It is particularly preferable for the transmit unit and/or receive unit to be configured to emit or receive optical signals. It is very particularly preferable for the transmit unit and/or receive unit to be configured to emit or receive light in the visible range. Since conventionally when a dishwashing machine is in operation it is dark inside the washing compartment, signals may be emitted and detected in the visible optical range, for example in the form of signal pulses or photoflashes.

Alternatively or in addition, it is advantageous for the transmit unit and/or receive unit to be configured to emit or receive infrared signals. It is particularly advantageous for the transmit unit and/or receive unit to be configured to emit or receive infrared signals in the near infrared range (780 nm-3000 nm).

In particular, the transmit unit comprises at least one LED. Particularly preferably, the transmit unit comprises at least two LEDs. It is very particularly advantageous in this case for at least two LEDs to be arranged at a transmission angle offset by 90° relative to one another. In this way, the risk of signal shadows, in which a freely positionable signal receiver, in particular a dispenser, could be situated may be reduced by the multiple reflections produced inside the dishwasher.

It is also possible according to a further development of the invention which is to be preferred to provide at least two LEDs, which emit light at different wavelengths. This makes it possible, for example, to define different signal bands on which information may respectively be transmitted or received.

In addition, it is advantageous, in a further development of the invention, for at least one LED to be an RGB LED, the wavelength of which is adjustable. Thus, for example, different signal bands which emit signals on different wavelengths may be defined with one LED. It is thus for example also conceivable for light to be emitted on a different wavelength during the drying process, during which high atmospheric humidity (fog) prevails in the washing compartment, than for example during a washing stage.

The transmit unit of the release device may be configured in such a way that the LED is provided both for emitting signals inside the dishwasher, in particular when the dishwashing machine door is closed, and for optical indication of an operating state, for example the filling level of the salt or rinse aid storage container of a dishwashing machine, in particular when the dishwashing machine door is open.

It is particularly preferable for an optical signal to be configured as a signal pulse or a sequence of signal pulses with a pulse duration of between 1 ms and 10 seconds, preferably between 5 ms and 100 ms.

In addition, it is advantageous for the transmit unit to be configured in such a way that it emits an optical signal with the dishwashing machine closed which brings about an average illuminance E of between 0.01 and 100 lux, preferably between 0.1 and 50 lux, measured at the walls bounding the washing compartment. This illuminance is then sufficient to bring about multiple reflections with or from the other washing compartment walls and thus to reduce or prevent possible signal shadows in the washing compartment, in particular when the dishwashing machine is loaded.

The receive unit of the release device may in particular comprise a photodiode.

In a further development of the invention, the release device may additionally or alternatively also be configured to emit or receive radio signals.

The signal emitted by the transmit unit and/or received by the receive unit in particular bears information, in particular a control signal.

It is particularly preferable for the release device to be arranged in the door of a dishwashing machine.

In addition, a receptacle for detachably fixing a dispenser to the release device may be provided on the release device. In this way it is possible, for example, to position the dispenser not only in the crockery drawer of a dishwasher, but also directly on a release device for the dishwasher, in particular a combi dispenser. In this way, on the one hand no loading space in the crockery drawer is occupied by the dispenser, while on the other hand defined positioning of the dispenser relative to the release device is achieved.

Frequently, release devices such as a combi dispenser comprise a swivelable flap, which is opened during a washing program in order to release cleaning preparations located in the dispensing chamber of the combi dispenser into the interior of the dishwashing machine. The receptacle for the dispenser may then be configured on the release device in such a way that opening of the flap is prevented when the dispenser is fixed in the receptacle. This prevents the risk of double dispensing from the dispenser and the release device.

Moreover, it is advantageous to configure fixing of the release device and the transmit and/or receive unit in such a way that at least the transmit unit directly irradiates the receiver of the dispenser arranged in the fixing.

Advantageously, the dispenser not connected firmly to the dishwasher, for use in a dispensing system comprising the release device, comprises at least one receive unit and/or at least one transmit unit for wirelessly transmitting signals from the interior of the dishwasher to the release device or for wirelessly receiving signals from the release device.

1. A dispensing system for positioning in the interior of a dishwashing machine, comprising:
A.) at least one cartridge for flowable washing or cleaning agents with a plurality of chambers for spatially separate accommodation of in each case different preparations of a washing or cleaning agent: and
B.) a dispenser couplable with the cartridge; comprising:
i.) at least one energy source;
ii.) a control unit;
iii.) a sensor unit;
iv.) at least one actuator, that is connected with the energy source and the control unit in such a manner that a control signal from the control unit brings about movement of the actuator;
v.) a closing element, that is coupled with the actuator such that movement of the actuator displaces the closing element into a closure or a release position;
vi.) at least one dispensing chamber that, when cartridge and dispenser are assembled, is connected in communicating manner with at least one of the cartridge chambers; each dispensing chamber comprising:
a.) an inlet for inflow of washing or cleaning agent from a cartridge chamber and an outlet for outflow of washing or cleaning agent from the dispensing chamber into the surrounding environment; and
b.) at least the outlet of the dispensing chamber being closable or openable by the closing element;
wherein the dispenser comprises at least one first interface, that interacts, through transmission of signals and/or electrical energy, with a corresponding interface embodied in or on a dishwashing machine.

2. The dispensing system according to claim 1, wherein the dispenser and the dishwashing machine comprise at least one interface in each case for transmitting electromagnetic signals and/or electrical energy.

3. The dispensing system according to claim 2, wherein the interfaces are embodied by plug-in connectors, or so as to produce a wireless transmission of electromagnetic signals and/or electrical energy.

4. The dispensing system according to one of claims 3, wherein at least two corresponding interfaces are inductive transmitters or receivers of electromagnetic waves.

5. The dispensing system according to claim 4, wherein at least one interface of the dishwashing machine is embodied as an AC-operated transmitter coil with an iron core and at least one corresponding interface of the dispenser as a receiver coil with an iron core.

6. The dispensing system according to claim 1, wherein at least one interface is provided in each case on the dispenser and dishwashing machine for transmitting electromagnetic signals, wherein the signals represent operating state, measurement and/or control information of the dispenser and/or the dishwashing machine.

7. The dispensing system according to claim 6, wherein the interfaces are configured for emitting and/or receiving optical signals.

8. The dispensing system according to any one of claims 7, wherein an optical signal is configured as a signal pulse or a sequence of signal pulses with a pulse duration of between 1 ms and 10 seconds.

9. The dispensing system according to any one of claims 8, wherein at least one interface is embodied as an optical transmit unit having a light source that emits light in the visible and/or IR range.

10. The dispensing system according to claim 9, wherein at least one optical transmit unit comprises at least two LEDs that are arranged at a transmission angle offset by 90° relative to one another.

11. The dispensing system according to claim 9, wherein at least one interface emits an optical signal, in particular in the wavelength range from 600-800 nm, that, with the dishwashing machine closed and unloaded, brings about an average illuminance E of between 0.01 and 100 lux, measured at the walls bounding the washing compartment; and the walls of the washing compartment have in particular an average degree of gloss of at least 10 gloss units, particularly preferably at least 45 gloss units measured according to DIN 67530 with 60° geometry.

12. The dispensing system according to 8, wherein at least one interface is embodied as an optical receive unit selected from the group of the photocells, photomultipliers, semiconductor detectors, photodiodes, photoresistors, solar cells, phototransistors, CCD and/or CMOS image sensors, which receive light in the visible and/or IR range.

13. The dispensing system according to claim 1, wherein the dispenser and/or the dishwashing machine comprises at least one light guide, through which light is guided from the interior of the dishwashing machine to an optical transmit and/or receive unit, into and/or out of the interior(s) of the dispenser and/or of the dishwashing machine.

14. The dispensing system according to claim 13, wherein the incoupling and/or outcoupling point of the light guide is of lenticular and/or prismatic construction.

15. The dispensing system according to one of claims 13, wherein at least two incoupling or outcoupling points of the light guide relative to the surrounding environment are provided on the dispenser, the incoupling or outcoupling points on the dispenser being substantially opposite one another.
